(19) United States
(12) Patent Application Publication
(10) Pub. No.: US 2021/0323024 A1
(43) Pub. Date: Oct. 21, 2021

(54) Dripless Caulking Gun

(71) Applicant: Larry Childs, Cotati, CA (US)

(72) Inventor: Larry Childs, Cotati, CA (US)

(21) Appl. No.: 17/362,744

(22) Filed: Jun. 29, 2021

(51) Int. Cl. B05C 17/01

(52) U.S. Cl. CPC B05C 17/0116; B05C 17/0123

(57) ABSTRACT

A dripless caulking gun comprises a low friction bushing to enhance a dripless function by allowing the rod to retract more smoothly during the “dripless” phase of operation. The bushing may be changed to accommodate either a round rod or a hex shaped rod. Novel bushing designs allow rotation of the round rods but constrain the rotation of the hex shaped rods.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to caulking guns. More particularly, the invention relates to means and methods of creating and using low friction bushings, cage cradle systems and rotating cradles.

### (2) Description of the Related Art

The known related art fails to anticipate or disclose the principles of the present invention. In the prior art, caulking guns are prone to drip upon retraction.

Thus, there is a need in the art for the present invention.

### BRIEF SUMMARY OF THE INVENTION

The present invention overcomes shortfalls in the related art by presenting an unobvious and unique combination and configuration of methods and components to create a series of dripless caulking guns using low friction bushings, cradle systems and mounting methods to provide a dripless application of calk and other materials.

The invention overcomes shortfalls in the related art by providing means and systems to accommodate and improve both round and hex shaped shafts often used with caulking guns.

These and other objects and advantages will be made apparent when considering the following detailed specification when taken in conjunction with the drawings.

### BRIEF DESCRIPTION OF THE DRAWINGS

FIG. 1 depicts a perspective view of a rod tool with a rotating cradle and clean out

FIG. 2 depicts three more views of FIG. 1

FIG. 3 depicts an exploded view of the tool of FIG. 1

FIG. 4 depicts views of a universal handle

FIG. 5 depicts low friction bushing elements

FIG. 6 depicts views of a round cradle with a bushing pocket

FIG. 7 depicts views of a hex rod skeleton embodiment with a cradle that does not rotate

FIG. 8 depicts views of a skeleton cradle

FIG. 9 depicts elements of a ratchet rod embodiment with a cradle that does not rotate

FIG. 10 depicts cross sectional views or a ratchet embodiment

FIG. 11 depicts various views of a twin tube embodiment

FIG. 12 depicts a one to one mix configuration

FIG. 13 depicts a two to one mix configuration

FIG. 14 depicts a ten to one mix configuration

FIG. 15 depicts an embodiment ready to load with an open lid

### REFERENCE NUMERALS IN THE DRAWINGS

1: Universal Handle
2. Universal Trigger
3. Drive Pin
4. Trigger Axle
5. Drive Pin Rivet
6. Trigger Return Spring
7. Trigger Axle Rivet
8. Round Actuator Rod
9. Dripless Disk
10. Round Rod Drive Dog
11. Round Rod Low Friction Bushing
12. Clean out Rod
13. Dripless Disk Spring
14. Self Locking Nut
15. 10 oz Pusher Disk
16. Drive Dog Return Spring
17. Round Rod Cradle Bushing
18. Universal 10 oz Full Cradle
19. Hex Rod Low Friction Bushing
20. Hex Rod Cradle Bushing
21. Ratchet Drive Dog
22. Ratchet Drive Dog Spring
23. Ratchet Rod
24. Spring Pin
25. Rear Tie Bar Handle
26. 50 ml Tube Adapter
27. 50 ml Tube Retainer
28. 50 ml Auxiliary Drive Rod
29. 50 ml Center Drive Rod
30. 50 ml 1 to 1 Center Rod Disk
31. 50 ml 1 to 1 Auxiliary Rod Disk
32. 50 ml 2 to 1 Auxiliary Rod Disk
33. 50 ml 10 to 1 Center Rod Disk

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

Disclosed embodiments overcome shortfalls in the prior art by the novel design and implementation of a low friction bushing added to a caulking gun or originally built into a caulking gun to enhance the dripless function by allowing the rod to retract more smoothly during the “dripless” phase of operation. The bushing is changed to accommodate either a round rod or a hex shaped rod. Bushing embodiments may be used to allow a hex rod caulking gun a full rotation. Further advantages over the prior art include bushings in the cradle to allow the same cradle to be used on both round and hex rod tools. Further advantages over the prior art include new mounting methods of the clean out rod. Versions of the prior art use a rivet to retain the clean out rod while some of the disclosed embodiments use a detent formed in the rod that retains it once installed into the handle.

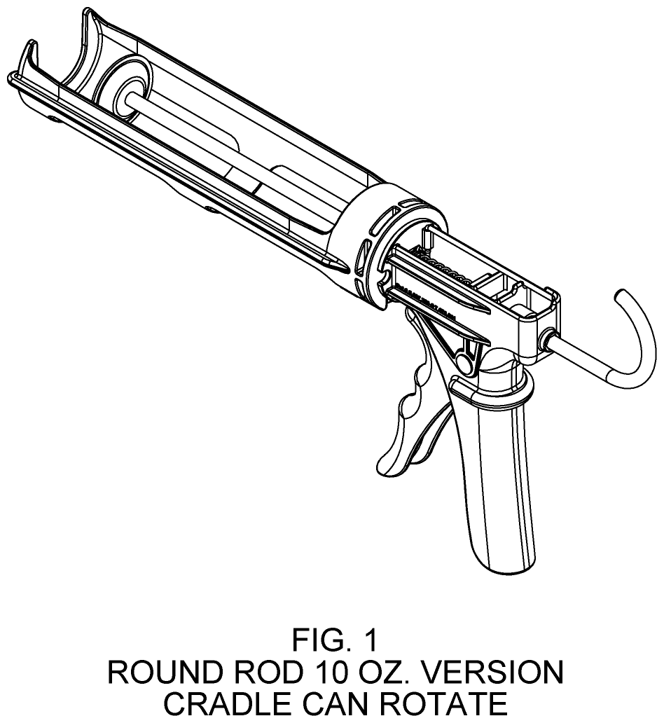

FIG. 1 depicts an isometric overview of the 10 oz round rod tool. This tool has a rotating cradle, and a clean out.

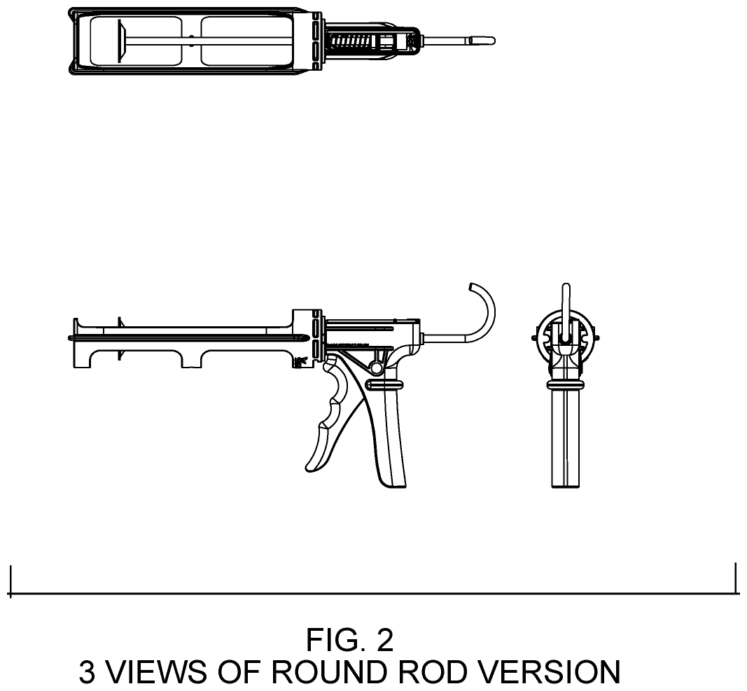

FIG. 2 comprises three views of the tool of FIG. 1.

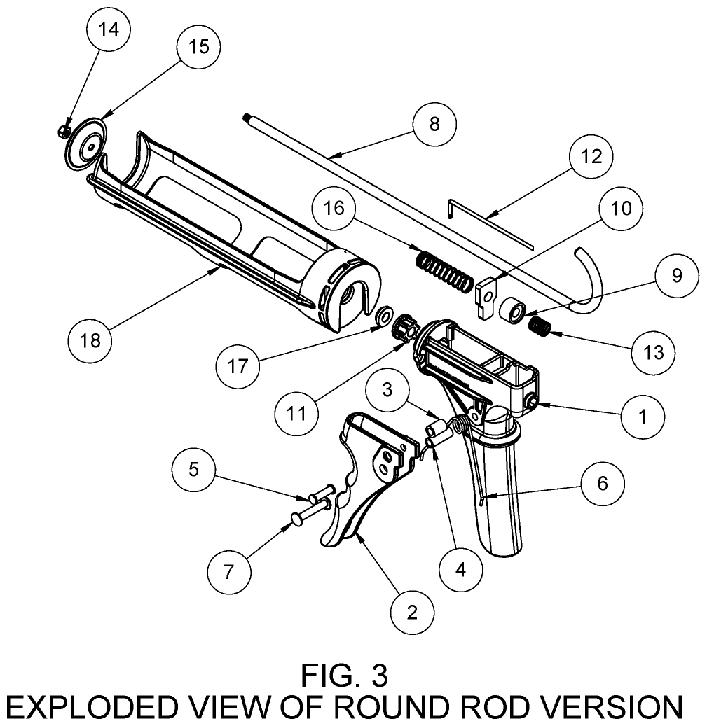

FIG. 3 is an exploded view of FIG. 1 with part numbers displayed. The part numbers are defined above.

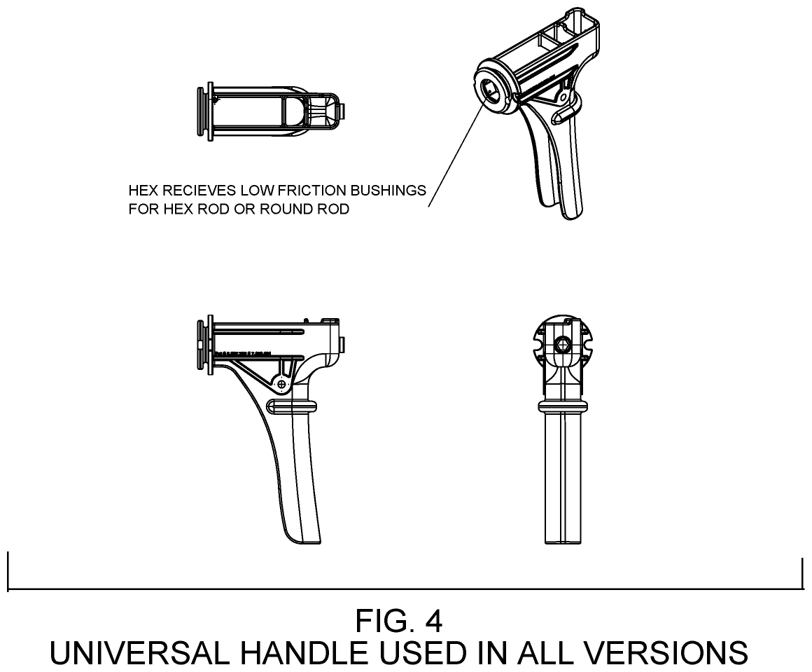

FIG. 4 depicts views of a universal handle.

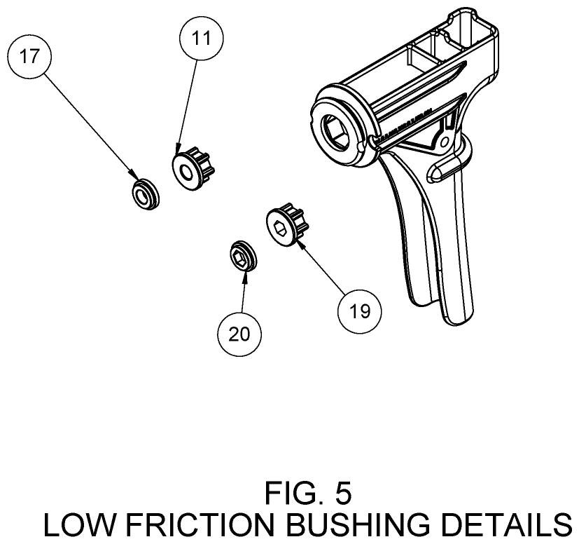

FIG. 5 depicts parts sometimes used to construct low friction bushings.

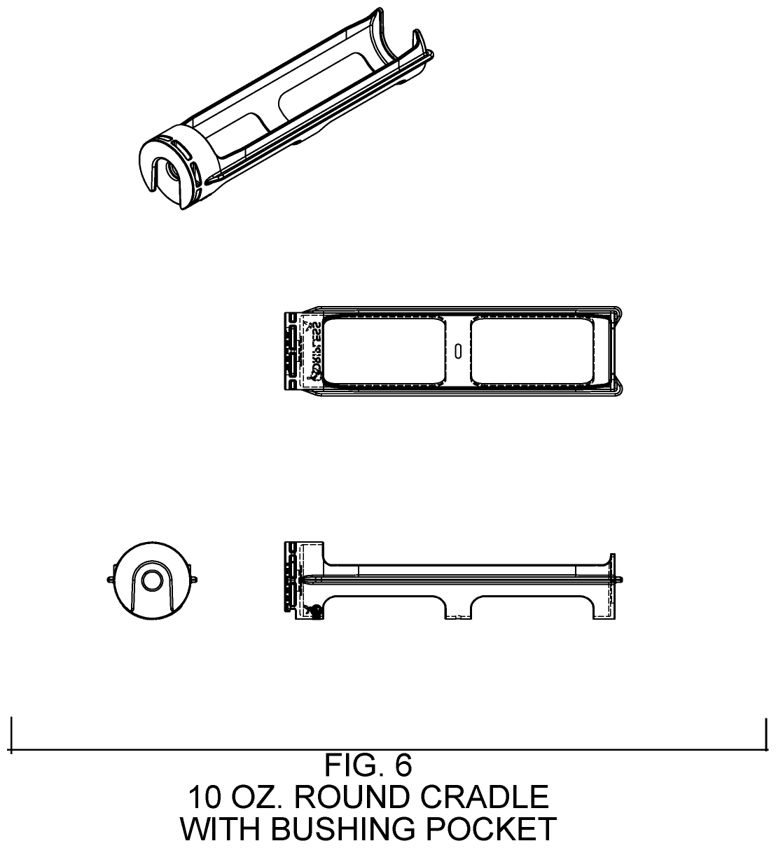

FIG. 6 depicts four views of a round cradle with a using pocket. Shows a 10 oz cradle with the pocket to receive the parts 17 or 20 bushing. The same cradle is also used in a hex rod version by only changing the two bushings and the drive dog.

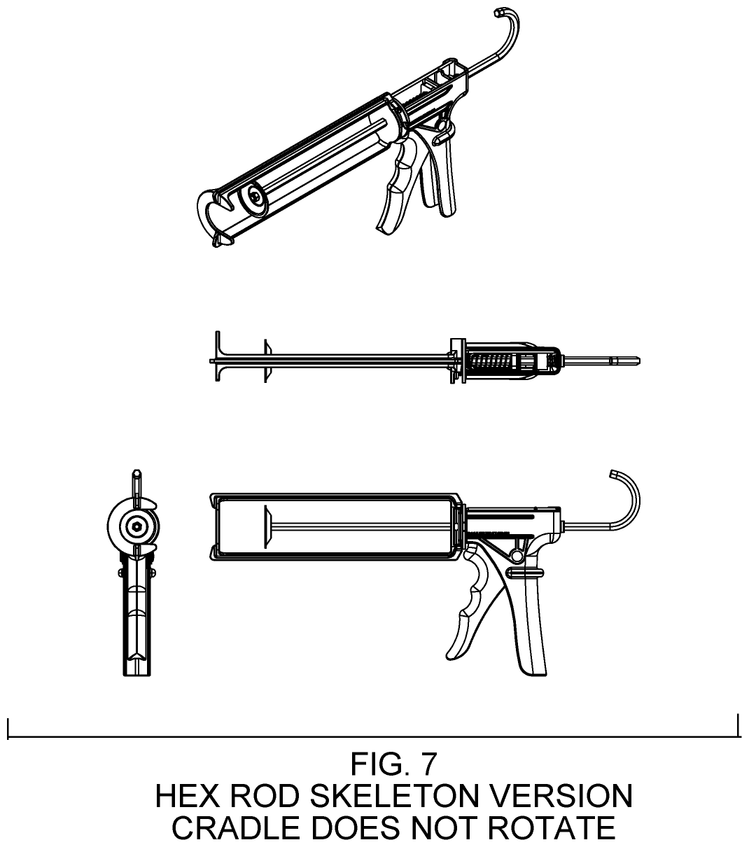

FIG. 7 depicts a non rotating embodiment with a hex rod. Shows the hex rod skeleton version of the tool. The hex rod is restricted from rotation but the part 19 bushing and the skeleton cradle is prevented from rotation by the tab that locks into the notch in the handle nose.

FIG. 8 depicts four views of a skeleton cradle. The tab molded in to prevent rotation.

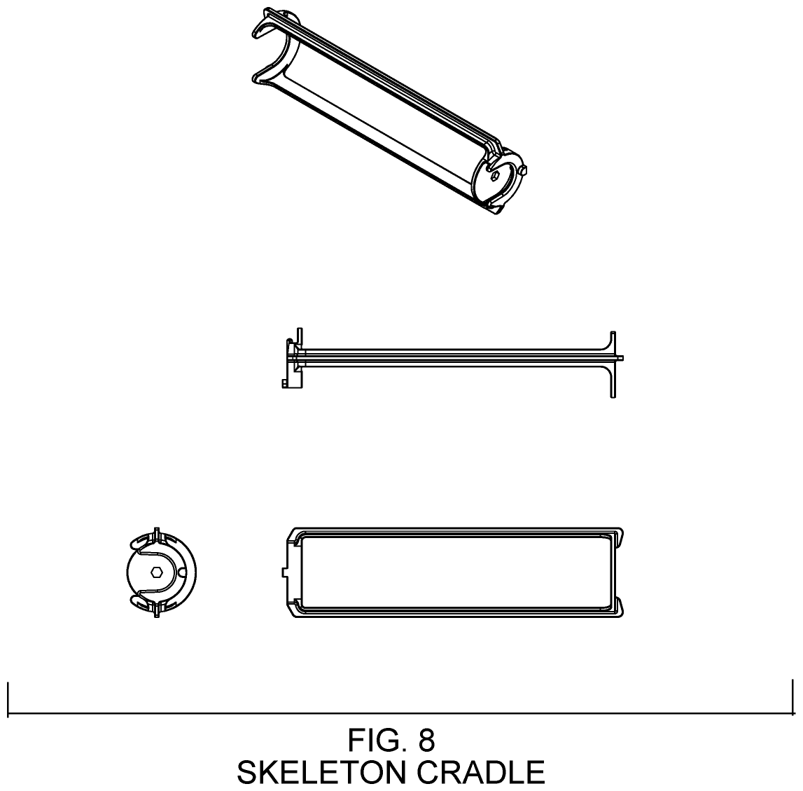

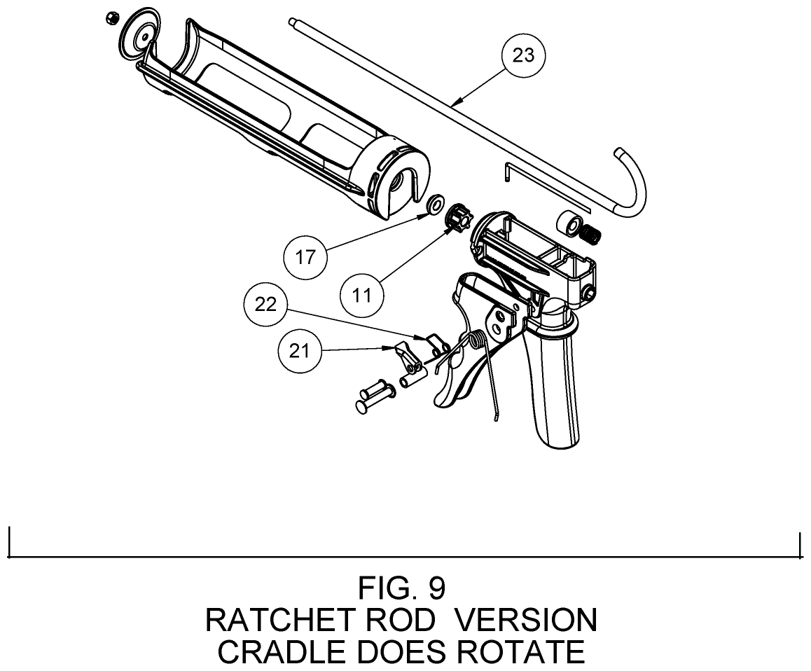

FIG. 9 depicts an exploded view of a ratchet rod embodiment with a cradle that does not rotate. The drive dog is replaced by a spring loaded ratchet dog that engages the teeth on the rod (see FIG. 10). Cradle can rotate. The low friction bushing will make a substantial change to the “dripless” operation of the ratchet rod version.

FIG. 10 depicts two cross section views of a ratchet embodiment.

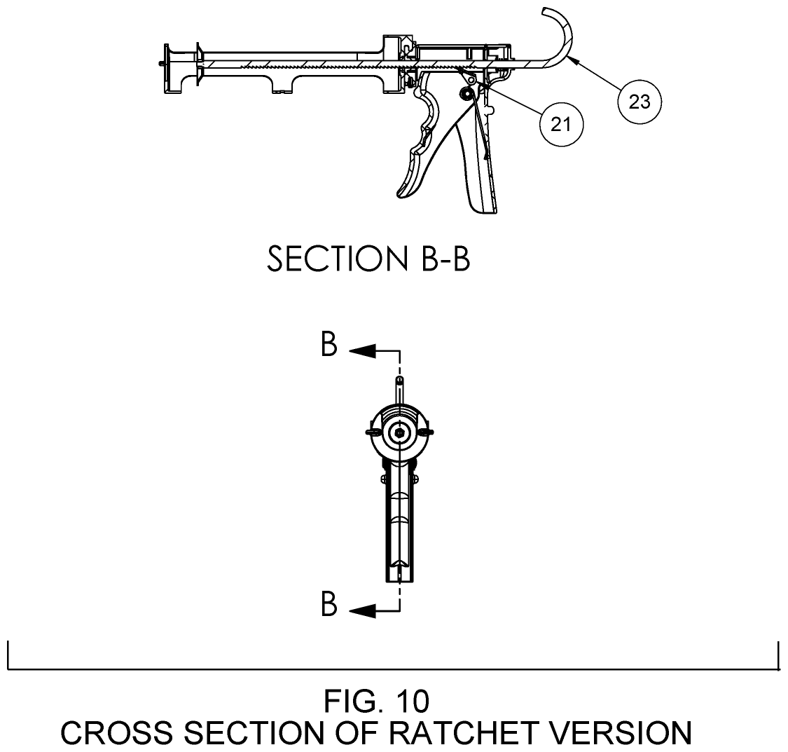

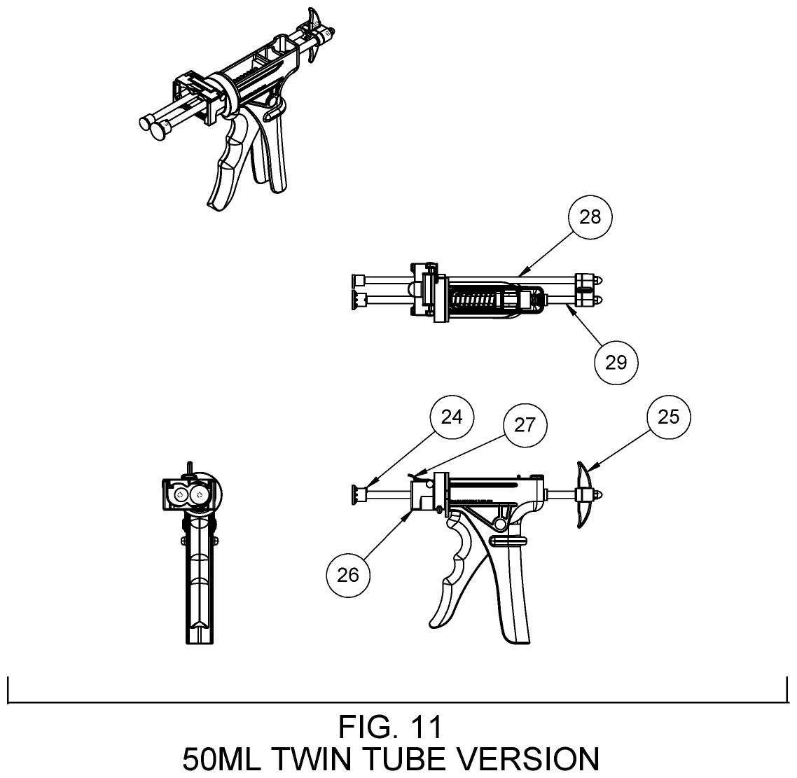

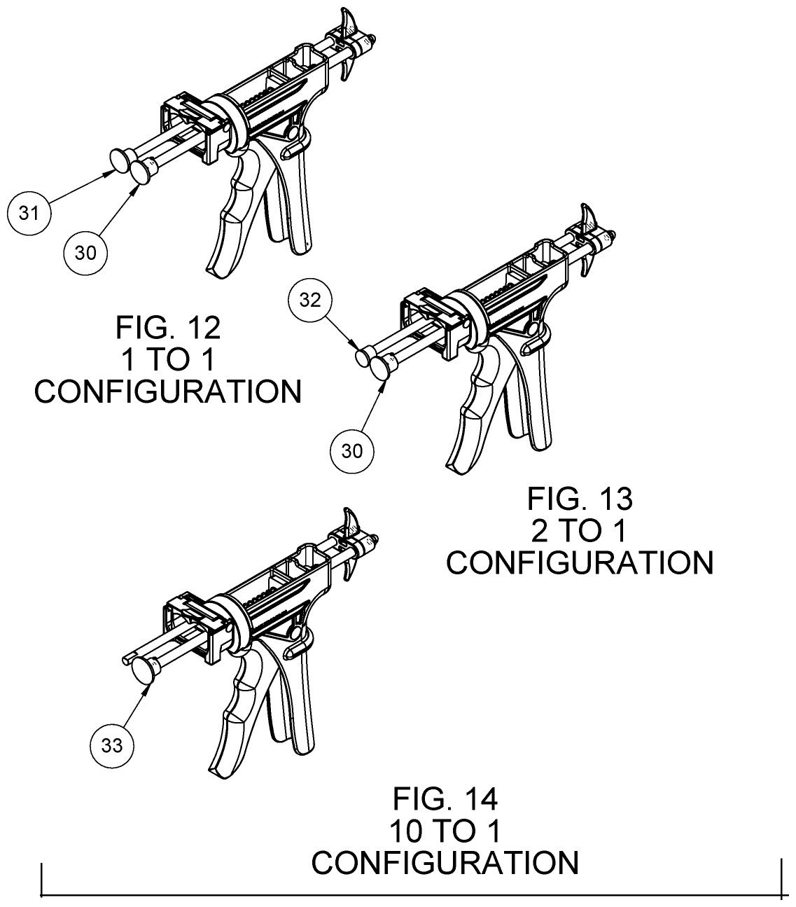

FIG. 11 depicts four views of a twin tube version that include four views of the 50 ml twin tube epoxy version of this tool. This tool uses interchangeable pusher disks to allow configuring by the end used for three different mix ratios. See FIGS. 12 to 14.

FIG. 12 to FIG. 14 depict various configurations. This drawing sheet shows three configurations of the pusher disks used. Note that the 10 to 1 configuration only uses a disk (part 33) on the Center Rod, and no disk on the Auxiliary Rod. The lengths of the Center and Auxiliary Rods are different, as are the Rod Disks. This allows the end face of the Auxiliary Rod to be co-planer to the 10 to 1 disk on the Center Rod. FIG. 14 has a 10 to 1 mix ratio.

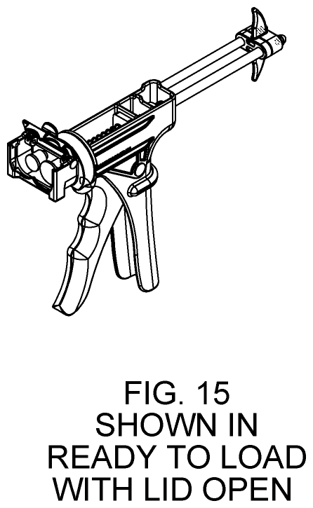

FIG. 15 depicts an embodiment with an open lid, read to be loaded. The tool is shown with the lid open and the rod retracted for loading a tube of epoxy. The primary rod and a spring pin installed (part 23) as retraction stop.

What is claimed is:

1. A caulking gun comprising:
a) a round rod cradle bushing disposed upon a round rod low friction bushing, with the round rod cradle bushing and the round rod low friction bushing disposed upon a front surface of a universal handle.

2. The caulking gun of claim 1 further comprising:
a) the universal handle comprising a drive pin securing a trigger return spring, a trigger axel, trigger axle rivet and universal trigger.

3. The caulking gun of claim 2 further comprising a cradle attached to the front surface of the universal handle.

4. The caulking gun of claim 3 further comprising:
a) a round activator rod disposed through the universal handle;
b) a drive dog return spring, round rod drive dog, dripless disk and dripless disk spring in frictional attachment and disposed with in the universal handle.

5. A caulking gun comprising:
a) a hex rod cradle bushing disposed upon a hex rod low friction bushing, with the hex rod cradle bushing and the hex rod low friction bushing disposed upon a front surface of a universal handle.

6. The caulking gun of claim 5 further comprising:
a) the universal handle comprising a drive pin securing a trigger return spring, a trigger axel, trigger axle rivet and universal trigger.

7. The caulking gun of claim 6 further comprising a cradle attached to the front surface of the universal handle.

8. The caulking gun of claim 3 further comprising:
a) a hex activator rod disposed through the universal handle;
b) a drive dog return spring, hex rod drive dog, dripless disk and dripless disk spring in frictional attachment and disposed with in the universal handle.
